(19) United States
(12) Patent Application Publication
(10) Pub. No.: US 2006/0090626 A1
(43) Pub. Date: May 4, 2006

(54) Musical instrument teaching and learning system and method

(76) Inventor: John Andrew Harrison, Hillsboro, OR (US)

Correspondence Address: IDEA ADVOCATES LAW GROUP PC, 239 NW 13TH AVE., SUITE 310, PORTLAND, OR, 97209, US

(21) Appl. No.: 11/257,604

(22) Filed: Oct. 24, 2005

Related U.S. Application Data
(60) Provisional application No. 60/623,512, filed on Oct. 28, 2004.

(51) Int. Cl. G10F 1/02

(52) U.S. Cl. 84/47

(57) ABSTRACT

The invented teaching method includes setting a token skill mastery task involving one or more repetitions of a two-handed digital maneuver by a student on a musical instrument; thereafter explaining the musical theory behind the maneuver; and associating the maneuver with a musical goal to reinforce the student's mastery of the skill. Preferably, the number of the one or more repetitions is based upon the student's level of skill mastery; the explaining includes asking the student one or more questions configured to elicit verbal responses of understanding; and the associating includes placing the skill in a musical context familiar to the student. The invented teaching system includes a skill drill tool defining a simple fingering, positioning or strumming skill to be mastered by a student; a knowledge development tool for imparting musical theory to the student that relates to a mastered skill, the knowledge development tool including a query/response protocol for posing one or more questions regarding the musical theory and for determining by answers thereto whether the student understands the musical theory; and a motivational tool for positively reinforcing the student's mastered skill by placing the mastered skill in a larger musical goal context.

### RELATED APPLICATIONS

The present application claims priority to U.S. Provisional Patent Application Ser. No. 60/623,512, entitled THE AMERICAN GUITAR ACADEMY GUITAR LEARNING SYSTEM and filed Oct. 28, 2004, the disclosure of which is incorporated herein in its entirety by this reference.

### BACKGROUND OF THE INVENTION

This invention relates generally to the field of musical instrument teaching and learning systems and methods. More particularly, it concerns a guitar teaching and learning system and method that promotes incremental student-paced skill mastery.

### SUMMARY OF THE INVENTION

The invented teaching method includes setting a token skill mastery task involving one or more repetitions of a two-handed digital maneuver by a student on a musical instrument; thereafter explaining the musical theory behind the maneuver; and associating the maneuver with a musical goal to reinforce the student's mastery of the skill. Preferably, the number of the one or more repetitions is based upon the student's level of skill mastery; the explaining includes asking the student one or more questions configured to elicit verbal responses of understanding; and the associating includes placing the skill in a musical context familiar to the student. The invented teaching system includes a skill drill tool defining a simple fingering, positioning or strumming skill to be mastered by a student; a knowledge development tool for imparting musical theory to the student that relates to a mastered skill, the knowledge development tool including a query/response protocol for posing one or more questions regarding the musical theory and for determining by answers thereto whether the student understands the musical theory; and a motivational tool for positively reinforcing the student's mastered skill by placing the mastered skill in a larger musical goal context.

### BRIEF DESCRIPTION OF THE DRAWINGS

FIG. 1 is a simplified hierarchical and ordered flow diagram illustrating the invented teaching and learning method in its broad concept.

FIG. 2 is a system block diagram illustrating the integrated tools that form the teaching/learning system in accordance with one embodiment of the invention.

FIG. 3 is a detailed flowchart illustrating the invented teaching/learning method in accordance with one embodiment of the invention.

### DETAILED DESCRIPTION OF THE PREFERRED EMBODIMENTS

The invention in accordance with a preferred embodiment involves teaching systems and methods for musical instruments such as guitars. Very briefly summarized, the invented system and method focuses on incremental mastery of skills by a student using segmented repetitive positive reinforcement at each step to achieve incremental mastery of various skills thereby.

The invented method and system relates to learning to play a musical instrument such as a guitar or bass guitar. Development of skill, knowledge and belief is systematically coordinated to create a fast and exciting experience of achieving one's goals on the musical instrument. This can be achieved through private individual lessons or home study. The traditional sequence of learning the guitar where skill development follows an explanation of what is being learned is reversed in the invented method, producing a surprisingly better result. With each small chunk of information presented, skill is developed first using quick, rapid repetitions called X-factor repetitions. Then, after the skill has been developed or transferred to muscle memory, an explanation follows as well as examples of how that skill can be used in the achievement of the student's goals.

Reversing the conventional training sequence creates the experience of empowerment and self-confidence. There is no room for the student to doubt his or her abilities. This is because, by the time the student is evaluating his or her progress in the explanation phase, he or she already has developed the skill: The student already has proven to himself or herself that he or she can do it. The student experiences additional excitement during the attachment-to-goal phase when he or she is shown how what has just been mastered is a vital step to reaching the student's own goals.

The three steps in this training process are:
1) skill development;
2) general musical explanation; and
3) attachment to student goals.
   These three steps are illustrated in the flowchart 100 of FIG. 1. The first step at block 102 is labeled “1) SKILL”, the second step at block 104 is labeled “2) KNOWLEDGE” and the third step at block 106 is labeled “3) BELIEF”, which three steps will be understood to correspond, respectively, to the above-listed steps.

The present invention relates to teaching methods and systems in general and in particular to a method of teaching the guitar and bass guitar that systematically coordinates the elements of skill, knowledge and belief to facilitate a fast, exciting and thorough experience of learning. The present invention is well suited for the age groups of 4 years and up. For ages 4-7 years, a six-lesson introduction is provided that corresponds with the attention span and interests of students in this age group, after which students from the introductory course move into the main program where all other age groups start.

Conventional teaching methods and systems in general and, specifically, methods of teaching music, do not address the importance of belief in the learning process. Moreover, conventional methods and systems do not utilize a system that monitors, develops and balances the elements of skill, knowledge and belief, in that order, but with cyclic repetition as new skills are mastered, throughout the method. Since learning a musical instrument requires both the acquisition of knowledge and the mastery of specific physical skills, the importance of a strong, positive belief in one's ability to gain both is of utmost importance. The element of belief is the least understood element and its underestimation can be the most detrimental in the ongoing mastery of an instrument. The technology in the invented system and method monitors and balances the three elements of skill, knowledge and belief throughout the process of mastering a musical instrument, e.g. a guitar.

Conventional methods focus primarily on the acquisition of knowledge and leave the specific details of how to develop skill up to the student. This creates sporadic results, because individual students may or may not appreciate or focus on the key elements that actually produce results in this area. The invented system and method, by contrast, use a step-by-step skill development process that guarantees results.

The knowledge portion of the American Guitar Academy™ Learning System is unique in the following ways.
1) The exact sequencing of information is designed to keep the student's knowledge acquisition in balance with his skill development and self confidence. Skills that are harder to master and concepts that are more difficult to understand come after a strong foundation of less difficult skill and conceptual understanding is achieved. As one's belief in his or her ability expands, so does the level of difficulty, preferably at the same rate. For example, the open chord shapes (chords used in the 1^{st} position using open strings) are mastered in Level 1 and are easily achievable to most beginning students both physically and conceptually. Many of these same chord shapes are then used in Level 2 to introduce the barred chords, which are more difficult to physically master and require the conceptual shift of moving chord shapes to different areas of the guitar neck.
2) So-called ‘informational chunking’ is used to lay conceptual foundations and to shorten learning time. Broad concepts are introduced using easy-to-understand metaphors before more detailed knowledge is presented. This reserves a space in the student's brain for the newly acquired skills where the student can easily access the information and understand how it relates to music as a whole in a broader sense. For example, in Level 1, a metaphor is introduced that involves the learning of the letters of the alphabet first, then spelling small words. This metaphor helps the student understand the process of mastering chords first, then putting them together to create different songs. Then, the student learns how to master chords and learns the fact that most songs use an average of only three to four chords. From that point the student learns a broad step-by-step sequence of how to learn any song followed by how to break songs into their smaller main components, verses and choruses.
3) Mental mapping is used to create mental templates to store increasingly advanced information while retaining a solid understanding of how it relates to all the other acquired knowledge. For example, in studying the pentatonic and diatonic scale patterns, a mental map is created while learning the pentatonic scales, the map effectively separating the guitar neck into four scale positions all of which are connected in the same key. When the student advances to learning the diatonic scales, the four-position map is used to plug in the new scales in the same positions and then the map is extended to include the extra three scales that do not fit in the four positions. Because of this, the student automatically knows how and when he can us his diatonic scales. This is because all the conceptual understanding from learning the pentatonic scales carries over to the new scales in the mental map.

The American Guitar Academy™ Learning System is broken into three levels. Each level is designed to lay conceptual foundations for the next level and to develop skills that naturally lead the student to the next level in the most economical way while building self confidence.

Level 1 Covers:

Open-position chords, measures, time signatures, tuning the guitar, reading rhythms, how to learn songs, how to learn the guitar successfully, X-factor repetitions.

Level 2 Covers:

E- and A-shaped bar chords, pentatonic scales, chords in major and minor keys, 1st position note reading, improvising, transposing.

Level 3 Covers:

Adding 7ths to chords in major and minor keys, all diatonic scales, chord inversions, arpeggios, double-stop scales, note reading in the most common keys and note reading in all positions.

Those of skill in the art will appreciate by now that the AGA™ Learning System has some key differences in concept from that of conventional methods. To begin with, the teacher student paradigm is shifted. Instructors are called “guitar coaches” and students are called “guitar experts.” Thus, the invented system and method begin with the belief that students have what it takes to achieve their own goals on the guitar and should be viewed as “guitar experts” from the start. Moreover, coaches think of their jobs as assisting or coaching their experts to achieve their goals as opposed to constructing a goal for them, as in a conventional teacher-student relationship. One other presupposition unique to the AGA™ Learning System is that the only difference between the results people get during skill development is that some peoples' muscles learn with fewer repetitions than others. The number of repetitions required for a guitar expert to master a skill is referred to as the guitar expert's X factor. So if an individual guitar expert's hand requires repeating an exercise ten times before it is mastered, then that individual guitar expert has an X factor of ten. This is not an exact method of measurement, but it equips guitar coaches and guitar experts a way to gauge progress, set expectations and determine how long to spend on skill development for any given lesson. Coaches are trained on how to assess a guitar expert's X factor and to balance it with the guitar expert's motivation level.

Those of skill will appreciate that, with a novel teaching/learning approach, novel terminology is required. The terms below are used herein to describe the invented system and method.

Guitar Expert: AGA™ customers are considered guitar experts because by using the AGA™ method, they become experts at each lesson before moving on. The best musicians are not the ones that know the most but the ones that use what they know to its full capacity and beyond.

Guitar Coach: AGA™ providers are guitar coaches who keep their guitar experts excited while meeting their musical goals by producing outstanding results. Guitar experts set the goal; guitar coaches help guitar experts clarify their goals and to help them get there with the maximum amount of excitement.

Mastering: AGA™ guitar experts are coached through the process of mastering each lesson. Mastery happens when a particular skill is in muscle memory; when the body has memorized it. The focus is on mastering, not practicing, each lesson. Practicing is boring; mastering is exhilarating! Repetition better describes the invented method and system. Practicing implies a long laborious almost unending process to many people, whereas repeating something until it is mastered is a much more accurate and exciting description.

X Factor: Every guitar expert has what it takes to reach his or her musical goals using the American Guitar Academy™ Learning System. The only difference between the amount of time it takes guitar experts to master each lesson is the number of times they need to repeat that lesson in order to master it. This number of times is called a guitar expert's X Factor (short for X number of times required). Each guitar expert's muscles require a certain number of repetitions until a skill is mastered. A guitar expert who needs a small number of repetitions has a low X Factor. A guitar expert who needs a large number of repetitions has a high X Factor.

The coach training is designed to give each guitar coach specific tools for the development of a guitar expert's skill, knowledge and belief. Coaches use specific techniques to get results in developing skill, knowledge and belief. These techniques are referred to as the guitar coach's tools. The toolkit that forms a part of the invented system includes three principal tools—a skill development tool, a knowledge development tool and a positive picture tool, to be described in detail below.

Skill Development Tool:

The main skill developmental tool is the X factor tool. For each skill that is being mastered, the guitar coach shows the guitar expert where to place his or her fingers and then directs the guitar expert to do quick repetitions of the movement (in the case of scales) or quick repetitions of the positions (in the case of chords). The repetitions go on until the guitar expert's X factor has been reached or until the guitar expert shows signs of fatigue or lack of excitement (in which guitar case the coach preferably breaks up the exercise into two or more nonconsecutive occurrences). Most X factor exercises last only a few minutes and produce the results of muscle memory in a much shorter time than with conventional teaching/learning systems or methods.

Knowledge Development Tool:

The main knowledge development tool is the question or query/response tool. As the guitar coach is explaining a new concept or principle, he or she will stop periodically to ask a specific question that requires the guitar expert to show that he or she has learned the material thus far or to lead the expert to the conclusion himself or herself. The question preferably requires a detailed answer, not yes or no, that lets the guitar coach know the guitar expert has understood the concept and is ready to proceed to the next step or, in case the guitar expert has reached his or her own conclusion, that he or she has come to the correct conclusion.

Positive Picture Tool:

The positive picture tool is a language refraining tool that is used to create and reinforce positive internal representations or associations, i.e. to reinforce one or more of a student's beliefs. The guitar coach uses this tool whenever he or she is directing the guitar expert to change any action or hand position on the guitar. Instead of telling the guitar expert what not to do, the guitar coach reframes the problem as a solution—telling the guitar expert precisely what action is needed. This is a small but very powerful distinction. What it does is create a positive internal representation or picture that the guitar expert then uses to effect the needed change and subsequently to recall it. This tool also reinforces positive beliefs about one's ability because beliefs are created by internal representations. When a guitar expert has mostly positive representations relating to the guitar, a positive belief in his or her ability is a natural consequence.

The positive picture tool is also used in the attaching-to-goals phase. Wen the guitar coach is explaining how a new skill will relate to the guitar expert's goals, he or she creates a scenario, or paints a picture, that gives the guitar expert a picture or internal representation of him or herself using the new skill in a situation that would be exciting to the expert. For example, if guitar expert John's goal is to play a certain Alan Jackson song to his girlfriend on the beach during summer break and he has just mastered the G chord (essential in playing this song), his coach might say “Now John, you've just mastered this G chord. You are going to play that G chord exactly like you're doing it right now when you're on the beach at night playing that Alan Jackson song for Jane in May on summer break because that G chord is the main chord in that song.” This storytelling imagery creates a very visceral connection with the material John just mastered and creates excitement about moving to the next skill.

The 3-Step Coaching Process

Guitar coaches are trained in this 3-step process that is used throughout the entire learning system. The coaching process preferably includes the following steps:
Step 1: Master the skill (use X factor tool until the X factor is reached, use positive picture tool to make physical adjustments)
Step 2: Explain (use question tool to lead the guitar expert to conclusions and ensure the guitar expert has it right)
Step 3: Attach to guitar expert's goals (use positive picture tool to connect the new skill to the guitar expert and to the guitar expert's individual goals)

Again, this allows the guitar expert to acquire the skill before learning what it is he or she has mastered, which allows positive beliefs to develop without the hindrance of doubt. Furthermore, the guitar coach explains how this new skill is useful in music in general. Then the guitar coach paints a powerful picture that shows how the guitar expert will use the skill to achieve the expert's own goals, which builds further excitement and reinforces the expert's positive belief in his or her ability.

The result triangle shown in FIG. 1 is a diagram used to show guitar coaches the interplay among skill, knowledge and belief. Guitar coaches use this as a reminder during lessons to determine where a guitar expert needs the most attention for a given lesson or exercise. At the beginning of a lesson, the guitar coach reviews the previous lesson and determines which area, i.e. skill, knowledge or belief, needs the most attention to bring the guitar expert back in balance and/or to move forward. Ultimately, the guitar coach strives to have his or her guitar expert be able to play everything the guitar expert knows and to have full confidence in his or her ability to move forward. Using the tools that form a part of the invented system, the guitar coach works to bring the guitar expert into balance in these three areas and to move forward in the lessons.

Most preferably, in accordance with the invention, guitar coaches are trained to direct successive lessons involving a given guitar expert based on the following criteria, in order:
1) the guitar expert's excitement level;
2) the guitar expert's expressed goals; and
3) the guitar expert's mastery of each lesson.
   The coach monitors these criteria and continues with any given activity only to the extent it is increasing (improving) the guitar expert's level of mastery. Lesson structure clearly can vary from guitar expert to guitar expert, but as a general rule, the following structure is used:
1) Review Last Lesson—5 min
2) 3-Step Coaching—15 min
3) Music/Goals—10 min

FIG. 1 represents a simplified, hierarchical, ordered flow diagram that illustrates the invented teaching/learning concept of the invention. The three vertices of the triangle labeled SKILL, KNOWLEDGE and BELIEF may be understood to correspond respectively with three coaching tools that form a part of the invented system, which coaching tools will be discussed in more detail below:
1) X-Factor Tool
2) Question Tool
3) Positive Picture Tool
   Coaching Tools

1) X-Factor Tool:
The X-factor tool is used to develop skill. Do quick repetitions of the exact movement or position until their X Factor has been reached. If necessary, take small breaks to avoid fatigue. When mastering a scale, break the scale into three or four sections, mastering each section along the way.

2) Question Tool
The question, or query/response, tool is used to develop knowledge. After introducing a new piece of knowledge, ask a quick question that requires them to repeat the key point back to you. Also use questions to lead your experts to a correct conclusion. Avoid questions that elicit or are capable of yes or no responses.

3) Positive Picture Tool
The positive picture tool is used to develop and reinforce positive beliefs. To create any behavioral change, reframe all statements to tell your experts exactly what you want them to do instead of what not to do. Place a picture of what you want the guitar expert's end result to look like in his or her mind. The picture is also used to paint a picture of the guitar expert using a newly mastered skill in achieving their goals (i.e. to put the guitar expert in the picture).

To briefly summarize, the invented 3-step coaching (teaching/learning) process (method) includes three key steps, most preferably ordered as follows:
1) Master the skill, e.g. repeat a two-handed digital maneuver on a musical instrument until the student's X factor is reached. Preferably, the number of repetitions of the digital maneuver, i.e. the student's X factor, is based upon the student's level of skill mastery.
2) Explain the skill, e.g. explain the musical theory behind the maneuver after the skill is mastered. Preferably, the explaining step includes asking the student one or more questions configured to elicit verbal responses of understanding. Most preferably, the one or more questions are configured not to elicit simple yes or no responses. Instead, the one or more questions are configured to elicit narrative answers in the student's own words that unmistakably confirm such understanding.
3) Attach the mastered skill to goals, e.g. associate the maneuver with a musical goal to reinforce the student's mastery of the skill. Preferably, the associating step includes placing the skill in a musical context familiar to the student.

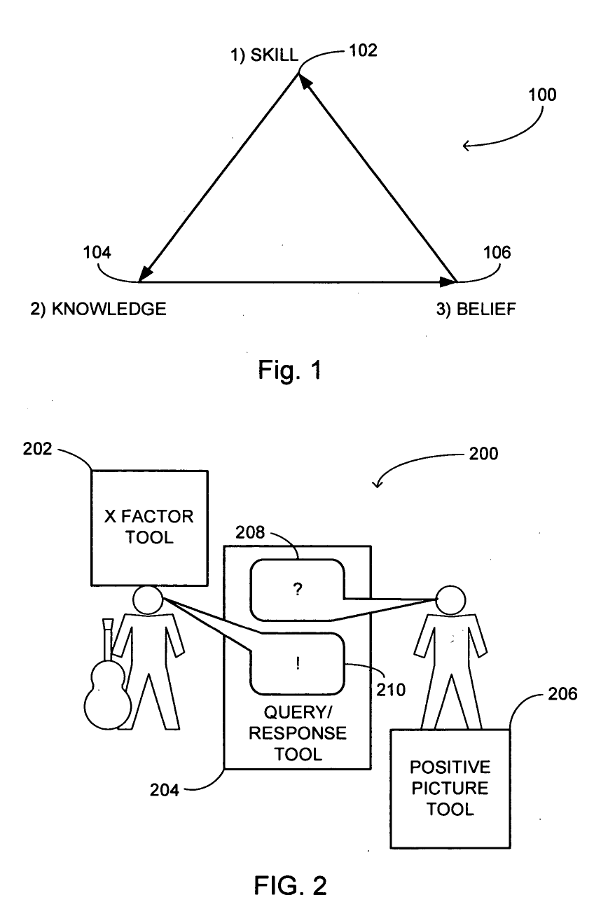

FIG. 2 illustrates the invented system indicated at 200 in the form of a system block diagram. System 200 includes a skill drill, or X factor, tool 202 embracing a repetition protocol by which a token skill is repeated until mastered. System 200 also includes a knowledge development, or query/response, tool 204 for imparting musical theory to a guitar expert. This tool 204 will be understood preferably to provide a query/response protocol indicated by the dialog bubbles 208, 210 representing verbalizations respectively from a guitar coach (on the right) and from a guitar expert (on the left, depicted with a stylized acoustic guitar). System 200 also includes a motivational, or positive picture, tool 206 that enables the guitar coach to give the guitar expert positive reinforcement.

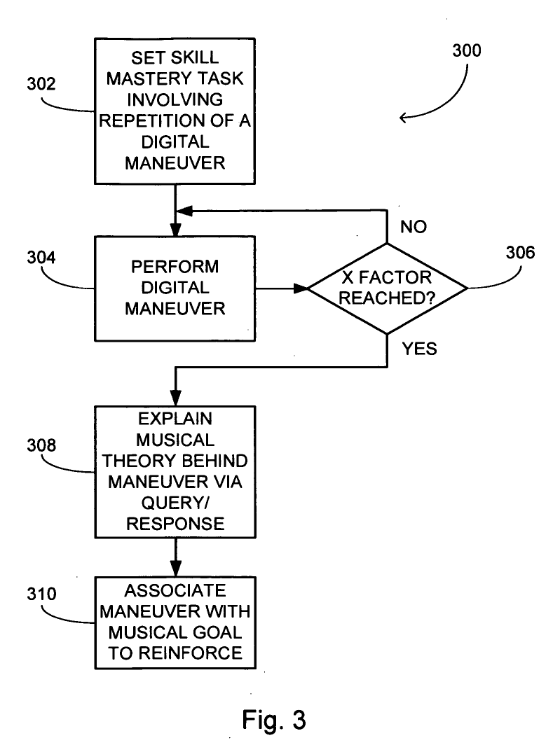

FIG. 3 illustrates the invented method indicated at 300 in the form of a flowchart.

The illustrated method preferably includes a) at block 302, setting a token skill mastery task involving one or more repetitions of a digital maneuver. Those of skill in the art will appreciate that such a digital maneuver can, for example, involve placement and positioning of one or more fingers on one or more strings between or on a given fret of the neck of a guitar to produce a quick chord. Or such a digital maneuver can involve moving the placed and positioned one or more fingers among different frets, whether up or down the guitar neck to produce a quick chord progression. Or such a digital maneuver can involve strumming or picking one or more strings of the guitar to produce a chord or a quick rhythmic run of individual notes.

Method 300 further includes b) at block 304, at least once performing the digital maneuver that realizes the set token skill mastery task, as described above.

Method 300 further includes c) at block 306, determining whether the guitar expert's X factor has been reached, i.e. whether the student has yet achieved mastery of the set token skill. If not, then the digital maneuver is performed again until mastery is achieved. When mastery is achieved, the digital maneuver and repetition thereof stops.

Method 200 further includes d) at block 308, explaining the musical theory behind the maneuver via a short query/response dialog between the guitar coach and the guitar expert. Preferably, the guitar coach explains the theory behind the just-mastered token skill and poses a question to the guitar expert intended to elicit a response that indicates understanding of the musical theory, rather than a simple yes or no response that may indicate a lack of understanding. For example, the guitar coach may say “You have just mastered the G chord. Explain what finger and hand position on the guitar's neck and strings represent a G chord.” The guitar expert hopefully will answer something like “The G chord has the middle finger on the A string, second fret, the ring finger on the top E string, third fret and the pinky finger on the bottom E string, third fret.”

Method 200 further includes e) at block 310, associating the maneuver with a musical goal to reinforce the guitar expert's mastery of the token skill. The example given above in which the guitar coach tells a story that places the guitar expert in a musical context with an opportunity to sing and play a favorite Alan Jackson song to his girlfriend at the beach during summer break is such a motivational or associational verbalization. Those of skill in the art will appreciate that, within the spirit and scope of the invention, the association may take alternative forms. For example, a picture may be drawn or painted for, or a gift or reward may be given to, the masterful guitar expert. Preferably, the associating is of the just-mastered token skill with a broader musical context that is meaningful and exciting to the guitar expert.

Skill tokens typically are short, easily repeated physical sequences that quickly develop muscle memory. As such, tokens typically would not include more than a few notes of a scale, or more than a few chord progressions, or more than a few strums or fingering sequences. Stated another way, token generally refers to a unit that is no longer or more difficult, approximately, than a musical phrase. This is because one of the great strengths of the invented method and system is in repetition only for so long as token skill mastery eludes the guitar expert, followed quickly and succinctly by an explication of the musical theory behind the mastered token skill, followed quickly by as much positive reinforcement as needed to maintain a high level of motivation and excitement in the guitar expert. Thus token is a relative term that it is believed is understandable in the musical instrument, e.g. guitar, teaching/learning context as referring to a relatively short, discreet, repeatable unit of physical manipulation of and tonal production on a musical instrument.

An invented learning method derives from the teaching method illustrated in FIG. 3 that includes a) digitally manipulating the strings of a guitar in a predefined way to develop a token skill; b) repeating the manipulating step until a defined level of token skill mastery is achieved (preferably until the X factor is reached and preferably using the X factor tool); c) acquiring musical theory knowledge regarding the token skill (preferably using the knowledge development/query response tool); and d) associating the token skill with a musical goal to reinforce learning (preferably using the positive picture tool). As described and illustrated herein, the last two steps c) and d) preferably occur only after the first two steps a) and b) are complete. Also as described and illustrated herein, the first two steps a) and b) are performed by the student under the teacher's guidance, the third step c) is initiated by the teacher and completed by the teacher and student in a dialog or question/answer sequence, and the fourth step d) is performed by the teacher. Those of skill in the art will appreciate, however, that the invented method and system lend themselves in the alternative to self-directed musical instrument study and skill mastery.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

From the foregoing, those of skill in the art will appreciate that several advantages of the present invention include the following.

The present invention provides a toolkit and protocols for teaching/learning a musical instrument by breaking the teaching/learning process into discreet, repeatable, physical units that are capable quickly and easily of building so-called muscle memory. Musical theory knowledge is imparted to the guitar expert quickly and in equally discreet units corresponding with the mastered skill, and such knowledge is preferably provided after rather than before mastery is achieved. Finally, guitar expert motivation is kept high by use of a motivational tool involving the placement of the mastered token skill into a broader musical goal context that is familiar to and thus provides positive reinforcement and excitement to the incrementally skill-mastering guitar expert.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

Accordingly, while the present invention has been shown and described with reference to the foregoing embodiments of the invented method, it will be apparent to those skilled in the art that other changes in form and detail may be made therein without departing from the spirit and scope of the invention as defined in the appended claims.

I claim:

1. A musical instrument teaching method comprising:
setting a token skill mastery task involving one or more repetitions of a two-handed digital maneuver by a student on a musical instrument; thereafter
explaining the musical theory behind the maneuver; and
associating the maneuver with a musical goal to reinforce the student's mastery of the skill.

2. The method of claim 1, wherein a number of the one or more repetitions is based upon the student's level of skill mastery.

3. The method of claim 1, wherein the explaining includes asking the student one or more questions configured to elicit verbal responses of understanding.

4. The method of claim 3, wherein the one or more questions is configured not to elicit simple yes or no responses.

5. The method of claim 1, wherein the associating includes placing the skill in a musical context familiar to the student.

6. The method of claim 5, wherein the associating includes verbalizing.

7. The method of claim 5, wherein the verbalizing includes storytelling.

8. A guitar learning method comprising:
digitally manipulating the strings of a guitar in a predefined way to develop a token skill;
repeating the manipulating step until a defined level of token skill mastery is achieved; thereafter
acquiring musical theory knowledge regarding the token skill; and
associating the token skill with a musical goal to reinforce learning.

9. The method of claim 8, wherein the manipulating is predefined by a teacher, and wherein the manipulating is performed by a student.

10. The method of claim 9, wherein the manipulating and repeating steps are performed before the acquiring step is performed.

11. The method of claim 10, wherein the manipulating, repeating and acquiring steps are performed before the associating step is performed.

12. The method of claim 11, wherein the token skill is short and simple and includes one or more skills selected from a group consisting of a positioning of the student's fingers over the strings on the neck of the guitar in a defined chord position, a defined strumming of the strings by the student's fingers to play a defined chord and a defined picking of the strings by the student's fingers in a defined non-chord sequence.

12. The method of claim 11, wherein the acquiring step is guided by the teacher.

13. The method of claim 12, wherein the associating step is guided by the teacher.

14. The method of claim 13, wherein the associating step includes verbalized placement by the teacher of the token skill into a larger musical context familiar to the student to positively reinforce learning.

15. A guitar teaching system comprising:
a skill drill tool defining a simple fingering, positioning or strumming skill to be mastered by a student;
a knowledge development tool for imparting musical theory to the student that relates to a mastered skill, the knowledge development tool including a query/response protocol for posing one or more questions regarding the musical theory and for determining by answers thereto whether the student understands the musical theory; and
a motivational tool for positively reinforcing the student's mastered skill by placing the mastered skill in a larger musical goal context.

16. The system of claim 15, wherein the skill drill tool includes a repetition protocol in accordance with an X factor representing the number of repetitions required for mastery.

17. The system of claim 16, wherein the one or more questions are configured to elicit verbal responses that are not simple yes or no responses.

18. The system of claim 17, wherein the motivational tool includes a protocol for associating the mastered skill with a musical goal in a context that is familiar to the student.

19. The system of claim 18, wherein the associating includes verbalizing.

20. The system of claim 19, wherein the verbalizing includes storytelling.
